(19) United States
(12) Patent Application Publication
(10) Pub. No.: US 2019/0095593 A1
(43) Pub. Date: Mar. 28, 2019

(54) LICENSE INFORMATION BASED ON BASEBOARD MANAGEMENT CONTROLLER

(71) Applicant: HEWLETT PACKARD ENTERPRISE DEVELOPMENT LP, Houston, TX (US)

(72) Inventors: Jorge Daniel CISNEROS, Houston, TX (US); Jeffrey A. NORDIN, Spring, TX (US); Lee A. PREIMESBERGER, Houston, TX (US)

(21) Appl. No.: 15/714,920

(22) Filed: Sep. 25, 2017

(51) Int. Cl. G06F 21/10; H04L 9/14; H04L 9/30

(52) U.S. Cl. CPC G06F 21/105; H04L 9/14; G06Q 2220/18; H04L 2209/603; G06F 2221/0704; H04L 9/30

(57) ABSTRACT

Examples disclosed herein relate to using a baseboard management controller (BMC) of a computing device with a private and public key that is used for license provisioning. A public key is obtained from the BMC. The public key is sent to a license device external to the computing device. Encrypted license information is received from the license device. Decrypted license information is obtained from the BMC based on the encrypted license information.

### BACKGROUND

Service providers and manufacturers are challenged to deliver quality and value to consumers, for example by providing access to computing capabilities. A data center is a facility used to house computer networks, computer systems, and associated components, such as telecommunications and storage systems. Equipment in a data center may be in the form of servers mounted in rack cabinets. A data center may also include blade systems and/or cartridge systems that include servers mounted inside of an enclosure or chassis. Further consumers may have one or more server or workstation devices.

### BRIEF DESCRIPTION OF THE DRAWINGS

The following detailed description references the drawings, wherein:

FIG. 1 is a block diagram of a computing device capable of securely obtaining license information, according to an example;

FIG. 2 is a system for securely providing license information to a computing device with a baseboard management controller, according to an example;

FIG. 3 is a flowchart of a method for securely applying license information for a computing device, according to an example;

FIG. 4 is a block diagram of a computing device capable of securely obtaining license information, according to an example; and

FIG. 5 is a flowchart of a method for securely providing license information to a computing device, according to an example.

### DETAILED DESCRIPTION

Application stores or “App Stores” are an approach that many devices use for providing software executable on hardware to purchasers. However, the common model used in App Stores is difficult to use in a corporate or information technology (IT) environment for a number of reasons. For example, some computing devices, such as server devices tend to belong to multiple organizations during the course of their life. Further, workers frequently switch roles or jobs, which makes having a fixed owner model for software executable on hardware not viable. Further, many companies are not willing to give authority to technicians to purchase items at will from an App Store to control costs.

Instead, many companies have a purchasing department that issues an order for a stock keeping unit (SKU) that provides a key, which is entered by hand. Further, many times, a baseboard management controller (BMC) used to manage the computing device is not connected to the internet, but rather to an internal network or not connected. As such, ordering from an online source can be cumbersome for companies that want to upgrade software or licenses. The hassle creates a barrier to purchase that can prevent sales to users who would be otherwise interested in unlocking features of computing devices, such as BMC features, features of storage devices, speed features, features of software databases, etc.

Accordingly, examples described herein describe approaches that allow casual sales of licenses from systems through leveraging BMC features and also an embedded provisioning engine to provide a simple, secure, and fast method to allow the sale and provisioning of license keys. Further, the approaches described make the licenses themselves ‘sticky’ to a unit rather than an organization, much like a hardware component.

On initial boot of the computing device into the service operating system (OS) or provisioning engine in the factory, a unique private and public key are generated and ‘glued’ onto the system by being saved into the BMC storage. This storage is persistent and not replaceable.

When the service OS or provisioning engine boot, the licensing state of the computing device is inventoried and upgradeable devices can be flagged for a user. If the user expresses interest in an upgrade, the provisioning engine can collect available licenses, costs, SKUs, etc. from a license device. Upgrades can be shown to the user and a web page can be accessed at the computing device. In some examples, the web page can include a payment service for the licenses. Further, in some examples, the payment service can be implemented on a separate device. In some examples, the payment service is provided by a third party. The payment service can take payment for a transaction and provide confirmation (e.g., a token, a session identifier, etc.) to the license device confirming that payment was made and to unlock the license for the computing device. Encrypted license information can then be provided from the license device to the computing device. An encrypted store can keep the encrypted license information. In some examples, the license keys are encrypted in a one-way encryption scheme where the private key is needed to decrypt and access the stored licenses. The encrypted store can be persistent to allow for re-application of the licenses even if the computing device is not online.

With the approaches described herein, a user is able to purchase a license with little interference from the manufacturer of the computing device. For example, a user can use a group credit card or corporate expense card to purchase a license and the license can be tied to the computing device without having to go through separate creation of one or multiple accounts for the company. Moreover, in certain scenarios, the keys can be re-applied during boot or when the provisioning engine is accessed.

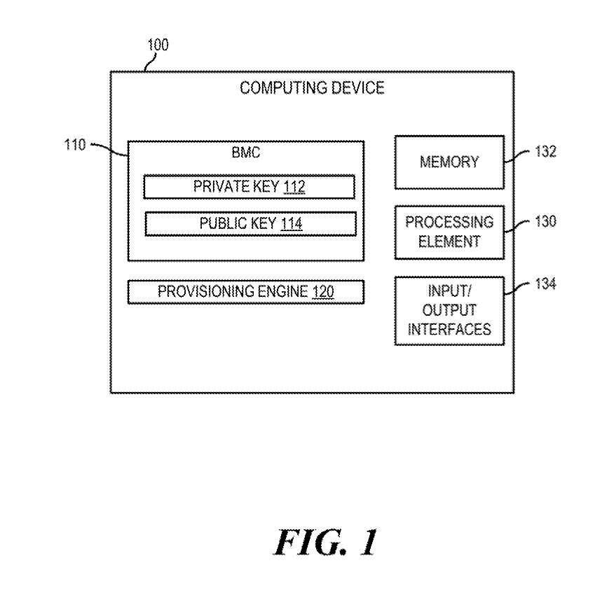

FIG. 1 is a block diagram of a computing device capable of securely obtaining license information, according to an example. Computing device 100 includes a BMC 110 that includes a private key 112 and public key 114, a provisioning engine 120, memory 132, a processing element 130 and input/output interfaces 134.

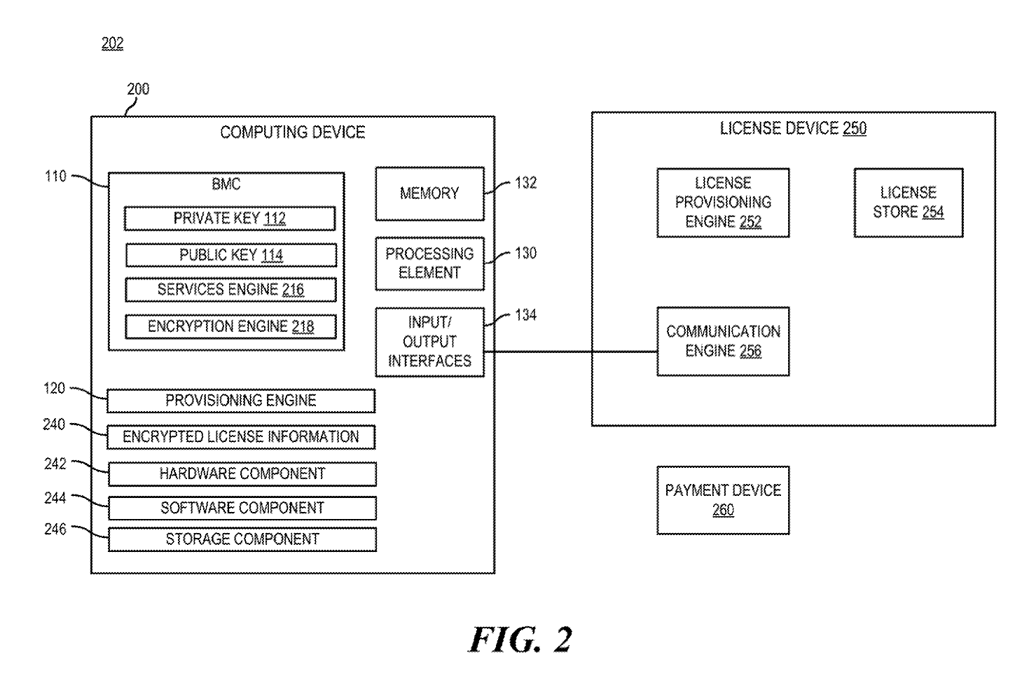

FIG. 2 is a system for securely providing license information to a computing device with a baseboard management controller, according to an example. The system 202 can include a computing device 200, licensing device 250, and a payment device 260. In this example, the computing device 200 includes a BMC 110, a provisioning engine 120, a processing element 130, memory 132, and input/output interfaces 134. In this example, the BMC 110 can include a private key 112, a public key 114, a services engine 216, and an encryption engine 218. Moreover, the computing device can further include encrypted license information 240, one or multiple hardware components 242 that can be enabled using licensing, one or multiple software component 244 that can be executed by hardware and enabled using licensing, and/or one or multiple storage component 246 that can be enabled using licensing. Respective computing devices 100, 200 may be implemented using a server, a workstation, a desktop computer, customized industrial machinery, or any computing device with the BMC 110 and provisioning engine 120 functionality described herein.

BMCs 110 provide so-called “lights-out” functionality for computing devices. The lights out functionality may allow a user, such as a systems administrator to perform management operations on the computing device 100, 200 even if an operating system is not installed or not functional on the computing device. Moreover, in one example, the BMC 110 can run on auxiliary power, thus the computing device 100, 200 need not be powered on to an on state where control of the computing device 100, 200 is handed over to an operating system after boot. As examples, the BMC 110 may provide so-called “out-of-band” services, such as remote console access, remote reboot and power management functionality, monitoring health of the system, access to system logs, and the like. As used herein, a BMC 110 has management capabilities for sub-systems of a computing device 100, 200, and is separate from a processor or processing element that executes a main operating system of a computing device (e.g., a server or set of servers).

As noted, in some instances, the BMC 110 may enable lights-out management of the computing device 200, which provides remote management access (e.g., system console access) via a services engine 216 to the computing device 200 regardless of whether the computing device 200 is powered on, whether a primary network subsystem hardware is functioning, or whether an OS is operating or even installed. The BMC 110 may comprise an interface, such as a network interface, and/or serial interface that an administrator can use to remotely communicate with the BMC 110. As used herein, an “out-of-band” service is a service provided by the services engine 216 via a dedicated management channel (e.g., the network interface or serial interface) and is available whether the computing device 200 is in powered on state. In some examples, a BMC 110 may be included as part of an enclosure. In other examples, a BMC 110 may be included in one or more of the servers (e.g., as part of the management subsystem of the server) or connected via an interface (e.g., a peripheral interface). In some examples, sensors associated with the BMC 110 can measure internal physical variables such as humidity, temperature, power supply voltage, communications parameters, fan speeds, operating system functions, or the like. The BMC 110 may also be capable to reboot or power cycle the device.

Further, as noted, the BMC 110 can include a private key 112 and public key 114. In one example, the private key 112 and public key 114 are stored inside a secure storage of the BMC 110. In another example, the private key 112 and the public key 114 can be set during a provisioning of the computing device 100, 200, for example, at a first boot up at a manufacturing site or at another time. The values can be written to a write once register on the same Application Specific Integrated Circuit (ASIC) as the BMC 110. The write once register can be implemented, for example, using fuses. In one example, the private key 112 is created by executing an algorithm using random sources and is programmed. In another example, the public key 114 is a cryptographic hash of the private key 112. In some examples, once programmed, the ability to change the registers is disabled (e.g., severing a fuseable link, for example, on a write line).

In some examples, the encryption engine 218 can provide an application programming interface (API) to decrypt information according to an approach. Thus, encrypted information using the public key 114 can be provided to the BMC 110 via the API. The BMC 110 can decrypt the information using the encryption engine 218 and the private key 112 (e.g., by executing an algorithm). The BMC 110 can then provide the decrypted information, via the encryption engine 218 to a requestor via the API.

In some examples, the API is provided via an interface internal to the computing device 200 (e.g., via an internal bus such as an inter-integrated circuit (I2C) bus, a peripheral bus, etc.). In other examples, the API can be provided to a source external to the computing device (e.g., via a networking interface connected to the BMC 110 for remote management).

In one example, the provisioning engine 120 can be used to enable licenses for the computing device 100, 200. In one example, the provisioning engine 120 is enabled via the BMC 110 as an out-of-band service. In another example, the provisioning engine 120 can be executed on a processing element 130, for example, during bring up of the system. For example, while the computing device 100 is being brought online, in input/output interface 134 such as a keyboard, virtual keyboard, etc. can push a button coded to cause the provisioning engine 120 to execute on the processing element 130. In some examples, code for the provisioning engine can be stored on flash memory, in a read only memory (ROM), etc. Further parts of the provisioning engine 120 can be stored on a system board of the computing device. Moreover, the provisioning engine may work in collaboration with other components, for example, option ROMs, network cards, storage controllers, etc.

While in the provisioning engine 120, licenses can be bought, applied, and the like. The provisioning engine 120 can inventory the computing device 200 to determine the licensing state of the computing device 200 and flag upgradeable licenses to a user. The inventory can be conducted by the provisioning engine 120, the BMC 110, or other components of the computing device 200. In some examples, the provisioning engine 120 can identify one or more hardware component 242, software component 244, or storage component 246. Examples of components 242, 244, 246 with licenses that can be unlocked can include capabilities of the BMC 110, capabilities of hardware components 242 such as a network controller, memory management, overclocking or speed adjustments of hardware components, redundant systems, etc., capabilities of software components such as a database, firmware executing on microcontrollers or the processing element, operating systems, etc., and capabilities of storage components 246 such as a controller for a redundant array of independent disks, speed capabilities of a storage controller, bandwidth capabilities of a storage device, etc. As used herein, a capability is a feature that can be unlocked with a license.

In one example, the provisioning engine 120 can obtain the public key 114 from the BMC 110. This can be via a request to the encryption engine 218. In some examples, the provisioning engine 120 can use an input/output interface 134 (e.g., a network interface card) to communicate with a communication engine 256 of a license device 250. The license device 250 can include a license store 254 that includes a database with license information. The public key 114 can be sent via the input/output interface 134 to the license device 250 to request license information. The request may be alone to retrieve the latest license information or can be associated with purchase of a new license.

In one example, a purchase of a new license can be selected from the available upgrades of the inventoried computing device 200. Input indicating a desire to obtain one or more license for a component or multiple components of the computing device 200 is received. Payment for the selected license or licenses can be provided via a web interface to a payment device 260. The payment device 260 may be implemented by a third party or the same party as the license device 250. The payment device 260 can be separate from the license device 250. Communication can be synchronized between the computing device 200, license device 250, and payment device using an identifier, such as a session identifier, a token, etc. In one example, the provisioning engine 120 takes payment information, such as credit card input, via a web interface to the payment device 260. An identifier is provided to the provisioning engine 120 with regards to the transaction. The provisioning engine 120 provides the identifier to the license provisioning engine 252. The payment device 260 can provide the identifier and indication or confirmation that payment was made to the license provisioning engine 252.

Once payment is made, the license provisioning engine 252 can enable the paid for license in a license store 254. Various implementations can be used for the license store 254. In one example, the license store 254 includes a table or other data structure linking identifiers for the computing device 200, in this case a public key 114 with license information for the computing device 200. In one example, the license information can include one or multiple codes that when provided to a component 242, 244, 246, cause the component to enable one or more features associated with the license.

In one example, the license store 254 is encrypted. In this example, the license store 254 provides an API to the license provisioning engine 252 to access information. In one example, the API can include an approach to enable licenses for computing devices based on the public key 114 and an identification of the license to be enabled. Because the public key 114 is used to identify the computing device and the public key 114 is created using the private key 112, the license is tied to the private key 112 and not the payment information or an account associated with the payment information. As such, the computing device 200 retains ownership of the license rather than a particular company.

In one example, an API can include a way to retrieve encrypted license information for the computing device 200. In one example, the license provisioning engine 252 retrieves license information for the computing device 200 in an encrypted form from the license store 254. The communication engine 256 can send the encrypted license information to the provisioning engine 120. In one example, because the license that was purchased was enabled in the license store 254, the license is included in the encrypted license information.

In another example, the license store 254 can be stored in a storage that is not directly exposed. The license store 254 can include the public key as an index and encrypted license codes that have been enabled for the public key. When a new license is purchased, a key generator can be used to generate the code and the code can be encrypted using the public key. The encrypted code is added to the database for the public key.

The provisioning engine 120 can receive the encrypted license information from the license device 250. In some examples, the provisioning engine 120 can store the encrypted license information 240 in a persistent storage of the computing device 200.

The provisioning engine 120 can provide encrypted license information to the BMC 110 to obtain decrypted license information. The encryption engine 218 can provide an API to the provisioning engine 120 to obtain the decrypted license information. The encryption engine 218 can take the encrypted license information and decrypt the license information using the private key 112. One of various encryption/decryption approaches can be used. Generally speaking, the public key is used to encrypt the information. The corresponding private key is used to decrypt the information. Example algorithms for encryption include Data Encryption Standard (DES), Rivest-Shamir-Adleman (RSA), Blowfish, Advanced Encryption Standard (AES), etc. The encrypted license information is encrypted at the licensing device using the public key 114 for the computing device 200. The encryption engine 218 provides the decrypted license information to the provisioning engine 120.

The provisioning engine 120 can apply the decrypted license information to the computing device 200. In one example, the license information can include an identifier of the component associated with a license and a license code. The license code can be applied to the component using an API provided by the component. The component can then use the code to enable the licensed capability. Multiple licenses can be applied with this approach.

In some examples, the provisioning engine 120 can determine whether new license information is included for the computing device 200 prior to application of decrypted license information. In other examples, the provisioning engine 120 can apply all of the licenses (e.g., by providing the corresponding codes to licensed components) regardless of whether the licenses were previously applied.

In some examples, the provisioning engine 120, can send the public key 114 to the license device 250 to request a new set of licensing information at startup of the provisioning engine 120. The public key 114 can be used by the license provisioning engine 252 to retrieve updated encrypted license information from the license store 254. The license device 250 can provide the encrypted license information to the provisioning engine 120.

In one example, the BMC 110 is one of the components for which a license is provisioned. The BMC 110 can receive the decrypted license information via an API. In response, the BMC 110 can enable one or multiple licensed features of the BMC 110. These features can be additional features that were not enabled in a base BMC 110 license. Examples of features that can be enabled via licensing include integrated remote console, group management capabilities, global team collaboration capabilities over remote console, remote console record and playback, virtual media via the integrated remote console, scripted virtual media, authentication capabilities, remote system log, advanced power management, discovery services, smart array secure encryption, and the like.

In some examples, configuration of a license can be lost, for example, if a storage component 246 is replaced. Accordingly, during boot of the provisioning engine 120 or based on input from a user, the provisioning engine 120 can apply decrypted license information to one or multiple components. In some examples, the encrypted license information 240 is stored at the computing device 200 and decrypted by the BMC 110 after the provisioning engine 120 is booted. Because the license information is sticky to the computing device 200, the decrypted license information can be applied to the replacement storage component 246 even if there was a previous license application to a different device. In some examples, part of the licensing scheme of the components includes the components checking to make sure that the computing device 200 being used has not changed. This can be during initialization of the component.

The engines 216, 218, 120, 252, 256 include hardware and/or combinations of hardware and programming to perform functions provided herein. In some examples, functionality attributed to a particular engine may also be implemented using another engine. In some examples, one or multiple engines can be used to implement one or more features of the devices 200, 250, 260.

A processing element 130 can include a processor such as a central processing unit (CPU) or a microprocessor suitable for retrieval and execution of instructions and/or electronic circuits can be configured to perform the functionality of one or multiple of the engines described herein. In certain scenarios, instructions and/or other information, such as operating system information, can be included in memory 132 or other memory. Input/output interfaces 134 may additionally be provided by the computing device 100, 200. For example, input devices, such as a keyboard, a sensor, a touch interface, a mouse, a microphone, etc. can be utilized to receive input from an environment surrounding the computing device 100, 200. Further, an output device, such as a display, can be utilized to present information to users. Examples of output devices include speakers, display devices, amplifiers, etc. Moreover, in certain examples, some components can be utilized to implement functionality of other components described herein. Input/output devices such as communication devices like network communication devices or wireless devices can also be considered devices capable of using the input/output interfaces 134.

The communication network (not shown) can use wired communications, wireless communications, or combinations thereof. Further, the communication network can include multiple sub communication networks such as data networks, wireless networks, telephony networks, etc. Such networks can include, for example, a public data network such as the Internet, local area networks (LANs), wide area networks (WANs), metropolitan area networks (MANs), cable networks, fiber optic networks, combinations thereof, or the like. In certain examples, wireless networks may include cellular networks, satellite communications, wireless LANs, etc. Further, the communication network can be in the form of a direct network link between devices. Various communications structures and infrastructure can be utilized to implement the communication network(s).

By way of example, the device 200, license device 250, and payment device 260 communicate with each other and other components with access to the communication network via a communication protocol or multiple protocols. A protocol can be a set of rules that defines how nodes of the communication network interact with other nodes. Further, communications between network nodes can be implemented by exchanging discrete packets of data or sending messages. Packets can include header information associated with a protocol (e.g., information on the location of the network node(s) to contact) as well as payload information. In some examples, computing device 200, payment device 260, and license device 250 can communicate via access to the Internet.

In some examples, provisioning engine 120 can be implemented as an operating system executing on a main processor of the computing device 200. Further, in some examples, the provisioning engine 120 can be implemented as part of a basic input output system or firmware interface.

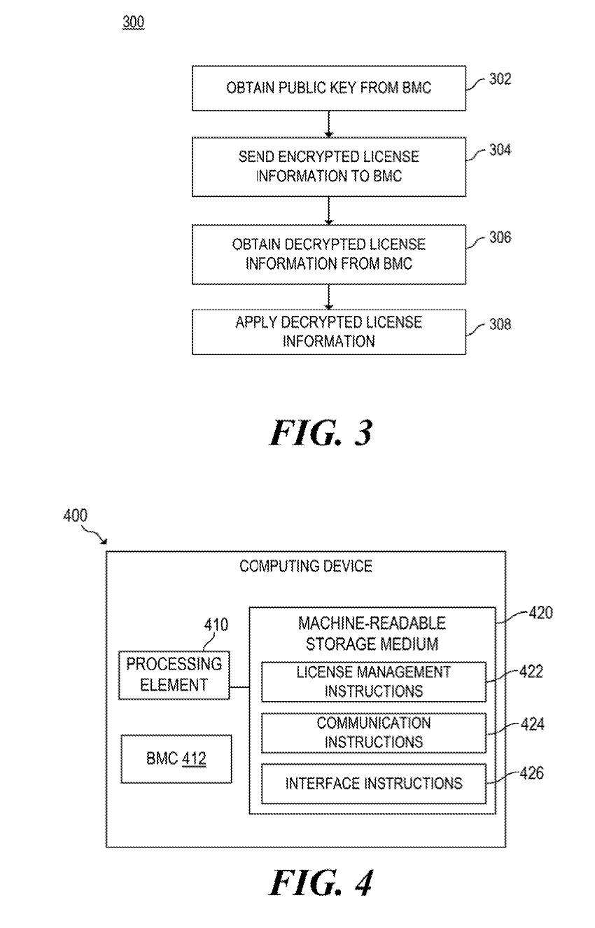

FIG. 3 is a flowchart of a method for securely applying license information for a computing device, according to an example. FIG. 4 is a block diagram of a computing device capable of securely obtaining license information, according to an example.

Although execution of method 300 is described below with reference to computing device 400, other suitable components for execution of method 300 can be utilized (e.g., computing device 100, 200). Additionally, the components for executing the method 300 may be spread among multiple devices. Method 300 may be implemented in the form of executable instructions stored on a machine-readable storage medium, such as storage medium 420, and/or in the form of electronic circuitry.

Computing device 400 can include a processing element 410, a BMC 412, and a machine-readable storage medium 420 including license management instructions 422, communication instructions 424, and interface instructions 426 that can be executed on the processing element 410.

License management instructions 422 can begin execution on the processing element 410. In some examples, the license management instructions 422 can be used to implement the provisioning engine described above.

At 302, the provisioning engine can obtain a public key from the BMC. The BMC can be embedded into the computing device. In some examples, embedded means that it is located on the system board of the computing device. As noted above, the BMC can include a public key and a private key and can be capable of providing at least one out of band service for the computing device. Moreover, the BMC 412 can be separate from the processing element 410 executing the license management instructions 422.

At 304, the processing element 410 can execute interface instructions 426 to interface with an API of the BMC 412 to send encrypted license information to the BMC 412. The BMC 412 can decrypt the encrypted license information using its private key to generate decrypted license information.

At 306, the provisioning engine obtains the decrypted license information from the BMC 412. As noted above, communications between the BMC 412 and the provisioning engine can be implemented via an API.

At 308, the provisioning engine can apply the decrypted license information to at least one component of the computing device 400. As noted above, application can include sending a code from the decrypted license information to the component via an API. The component can then process the code (e.g., accept the code and enable the corresponding feature associated with the license). In some examples, method 300 can be implemented on boot of the provisioning engine or upon a command.

In some examples, to obtain the encrypted license information, the communication instructions 424 are executed to communicate with an external license device and/or an external payment device. In one example, input is received indicating a desire to obtain a license for a component of the computing device 400. Further, payment information can be input for the license, for example, on a web page accessible by the computing device to the payment device. As such, payment information can be sent to the payment device. Confirmation of the payment can be provided to the license device from the payment device (e.g., using a transaction identifier). The license device can enable the paid for license in a license store. The public key can be provided to the license device to associate the computing device 400 with the license. As noted above, with this approach, the license is tied to the private key and not the payment information or an account associated with payment.

The provisioning engine can send the public key and a request for licensing information over a network to the license device. As noted, the public key can be used to retrieve the license information and encrypt the license information in a manner that the private key on the BMC 412 is to be used to decrypt the license information. The encrypted licensing information can then be decrypted and applied as described above. In some examples, the provisioning engine can request the encrypted licensing information as part of a startup procedure of the provisioning engine. In other examples, the request can be in response to input.

Processing element 410 may be, one or multiple central processing unit (CPU), one or multiple semiconductor-based microprocessor, one or multiple graphics processing unit (GPU), other hardware devices suitable for retrieval and execution of instructions stored in machine-readable storage medium 420, or combinations thereof. The processing element 410 can be a physical device. Processing element 410 may fetch, decode, and execute instructions 422, 424, 426 to implement method 300. As an alternative or in addition to retrieving and executing instructions, processing element 410 may include at least one integrated circuit (IC), other control logic, other electronic circuits, or combinations thereof that include a number of electronic components for performing the functionality of instructions 422, 424, 426.

Machine-readable storage medium 420 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, flash memory, a Compact Disc Read Only Memory (CD-ROM), and the like. As such, the machine-readable storage medium can be non-transitory. As described in detail herein, machine-readable storage medium 420 may be encoded with a series of executable instructions for perform the provisioning approaches described herein.

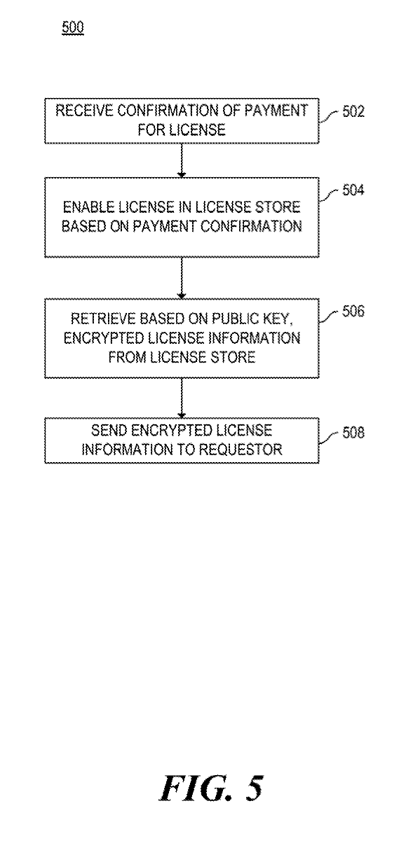

FIG. 5 is a flowchart of a method for securely providing license information to a computing device, according to an example. Although execution of method 500 is described below with reference to license device 250, other suitable components for execution of method 500 can be utilized. Additionally, the components for executing the method 500 may be spread among multiple devices. Method 500 may be implemented in the form of executable instructions stored on a machine-readable storage medium, and/or in the form of electronic circuitry.

The license device 250 can receive a request for a license to a particular component or feature from a computing device. The computing device can be identified using a public key. As described above, a third device can be used to accept payment for the transaction. A transaction identifier can be used to confirm payment of the transaction. The payment device can provide the confirmation to the license device 250. The license device 250 receives confirmation of the payment (502).

In response, the license device 250 enables the corresponding license for the computing device in the license store as described above (504). As noted above, the enabling can be implemented using an API. The public key can be used to identify the computing device in the license store.

At 506, the license device 250 can retrieve encrypted license information from the license store based on the public key. As noted above, the encrypted license information can be encrypted using the public key and identified using the public key. As such, licenses are tied to the device (and the private key that is used to decrypt the license information). At 508, the encrypted license information can be sent back to the requestor, the computing device.

In some examples, implementation of the license device 250 can be via a manufacturer of the computing device. Moreover, various approaches can be used to implement the license store 254. For example, a database can be maintained with license codes for each public key and a separate database can be maintained that includes which licenses are enabled for a particular public key. In another example, license codes can be separately generated and included in the license store for the public key when payment is provided. In some examples, a key generator can be used during the process. In this example, enabling a license can include using a key generator for that license and adding the generated license key to the database. In certain examples, the only keys exposed from the database is information that related to a particular public key and encrypted using the public key.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

What is claimed is:

1. A computing device comprising:
at least one processing element;
memory;
a baseboard management controller (BMC) separate from the at least one processing element that includes a private key and a public key,
wherein the BMC is to provide at least one out of band service for the computing device;
a provisioning engine executing on the at least one processing element to:
obtain the public key from the BMC;
send the public key and a request for license information over a network to a license device external to the computing device;
receive encrypted license information from the license device; and
obtain decrypted license information from the BMC based on the encrypted license information and the private key.

2. The computing device of claim 1, wherein the license information relates to at least one of: enablement of hardware of the computing device, enablement of capabilities of the BMC, and enablement of capabilities of a storage controller.

3. The computing device of claim 1, wherein the provisioning engine is further to:
receive input indicating a desire to obtain a license for a component of the computing device;
receive payment information for the license; and
send the payment information to a payment device separate from the license device,
wherein the license information includes the license.

4. The computing device of claim 3, wherein the license information including the license is in response to a confirmation of the payment information being received at the license device.

5. The computing device of claim 4, wherein the license remains tied to the private key and not the payment information.

6. The computing device of claim 1, wherein the provisioning engine is further to:
apply the decrypted license information to the computing device, wherein the BMC decrypts the encrypted license information using the private key to generate the decrypted license information.

7. The computing device of claim 6, wherein the provisioning engine sends the public key in response to a startup of the provisioning engine.

8. The computing device of claim 6, wherein the provisioning engine is further to determine whether new license information is included for the computing device prior to application of the decrypted license information.

9. The computing device of claim 7, wherein the BMC is to use at least a portion of the decrypted license information to enable at least one functionality of the BMC.

10. A non-transitory machine-readable storage medium storing instructions that, if executed by a physical processing element of a computing device, cause the computing device to:
begin execution of a provisioning engine;
obtain a public key from a baseboard management controller (BMC) embedded within the computing device,
wherein the BMC includes the public key and a private key and is capable of providing at least one out of band service for the computing device,
wherein the BMC is separate from the physical processing element;
send the public key and a request for license information for the computing device over a network to a license device external to the computing device;
receive encrypted license information from the license device;
send the encrypted license information to the BMC; and
obtain decrypted license information from the BMC based on the encrypted license information and the private key.

11. The non-transitory machine-readable storage medium of claim 10, further comprising instructions that, if executed by the physical processing element, cause the computing device to:
apply the decrypted license information to at least one component of the computing device using an application programming interface.

12. The non-transitory machine-readable storage medium of claim 10, further comprising instructions that, if executed by the physical processing element, cause the computing device to:
receive input indicating a desire to obtain a license for a component of the computing device;
receive payment information for the license; and
send the payment information to a payment device separate from the license device,
wherein the license information includes the license.

13. The non-transitory machine-readable storage medium of claim 12, wherein the license information including the license is in response to a confirmation of the payment information being received at the license device.

14. The non-transitory machine-readable storage medium of claim 13, wherein the license remains tied to the public key and not the payment information.

15. The non-transitory machine-readable storage medium of claim 13, wherein the provisioning engine sends the public key in response to a startup of the provisioning engine.

16. A method comprising:
obtaining, by a provisioning engine executing on a physical processing element of a computing device, a public key from a baseboard management controller (BMC) embedded within the computing device,
wherein the BMC includes the public key and a private key and is capable of providing at least one out of band service for the computing device,
wherein the BMC is separate from the physical processing element;
sending encrypted license information to the BMC;
obtaining decrypted license information from the BMC based on the encrypted license information and the private key; and
applying, by the provisioning engine, the decrypted license information to at least one component.

17. The method of claim 16, further comprising:
sending, by the provisioning engine, the public key and a request for license information for the computing device over a network to a license device external to the computing device;
receiving the encrypted license information from the license device.

18. The method of claim 17, further comprising:
receiving input indicating a desire to obtain a license for a component of the computing device;
receiving payment information for the license; and
sending the payment information to a payment device separate from the license device,
wherein the license information includes the license.

19. The method of claim 18, further comprising:
receiving, at the license device, confirmation of payment for the license;
enable the license for the license device in a license store;
retrieving, by the license device, based on the public key, the encrypted license information from the license store.

20. The method of claim 17, wherein the license remains tied to the private key and not the payment information.
